(19) United States
(12) Patent Application Publication
(10) Pub. No.: US 2025/0206178 A1
(43) Pub. Date: Jun. 26, 2025

(54) CHARGING MANAGEMENT DEVICE OF DESIGNATED FACILITY

(71) Applicant: TOYOTA JIDOSHA KABUSHIKI KAISHA, Toyota-shi (JP)

(72) Inventors: Makoto KAKUCHI, Tokyo (JP); Keiya NAGATA, Tokyo (JP)

(73) Assignee: TOYOTA JIDOSHA KABUSHIKI KAISHA, Toyota-shi (JP)

(21) Appl. No.: 18/925,268

(22) Filed: Oct. 24, 2024

(30) Foreign Application Priority Data
Dec. 22, 2023 (JP) 2023-217010

(51) Int. Cl. B60L 53/67; B60L 53/63

(52) U.S. Cl. CPC B60L 53/67; B60L 53/63

(57) ABSTRACT

A charging management device of a designated facility for concurrently providing a parking space for charging in which a charging device for charging a vehicle-mounted battery is installed, acquires an operation time of a designated facility, prohibits charging by the charging device in the parking space for charging during the operation time of the designated facility, and permits charging by the charging device in the parking space for charging using a designated power outside the operation time of the designated facility.

### CROSS-REFERENCE TO RELATED APPLICATION

This application claims priority to Japanese Patent Application No. 2023-217010 filed on Dec. 22, 2023, incorporated herein by reference in its entirety.

### BACKGROUND

### 1. Technical Field

The present disclosure relates to a charging management device of a designated facility, and in more detail, relates to a charging management device of a designated facility that jointly provides a parking space for charging where a charging device that charges a vehicle-mounted battery is installed.

### 2. Description of Related Art

Conventionally, as a charging management device of a designated facility of the type, a charging management device is provided that controls power supplied to a charging unit in accordance with at least one of a usage power of electrical equipment, a charging state of a storage battery, and time-band power usage fee information of a power source (for example, refer to Japanese Unexamined Patent Application Publication No. 2011-019363 (JP 2011-019363 A)). According to the control, it is possible for a charging outlet to be simply provided by anyone without large-scale electrical construction being necessary at a location where a charging unit is necessary. Moreover, it is possible for an increase in a basic cost of an electricity usage fee relating to the cost of electrical construction and a contract power capacity to be suppressed.

### SUMMARY

However, in a designated facility that has the charging management device, generally, charging equipment is also used during an operation time (during a working time) of the designated facility. Accordingly, it is necessary to make a contract with a power company for power that exceeds a sum power of power necessary for an operation of the designated facility and power necessary for charging by the charging equipment.

A charging management device of a designated facility of the present disclosure has a main objective of performing an adjustment between power by an operation of the designated facility and power necessary for charging by charging equipment.

A charging management device of a designated facility of the present disclosure adopts the following processes in order to achieve the main objective.

A charging management device of a designated facility of a first aspect of the present disclosure is
a charging management device of a designated facility that jointly provides a parking space for charging where a charging device that charges a vehicle-mounted battery is installed, in which the charging management device is configured to
acquire an operation time of the designated facility,
prohibit charging by the charging device in the parking space for charging during an operation time of the designated facility, and
permit charging by the charging device in the parking space for charging that uses designated power other than at the operation time of the designated facility.

A designated facility of the first aspect of the present disclosure jointly provides a parking space for charging where a charging device that charges a vehicle-mounted battery is installed. The charging management device of the designated facility is configured to acquire an operation time of the designated facility. The charging management device is configured to prohibit charging by the charging device in the parking space for charging during an operation time of the designated facility. The charging management device is configured to permit charging by the charging device in the parking space for charging that uses designated power other than at the operation time of the designated facility. Namely, charging by the charging device in the parking space for charging is permitted at a time when the designated facility is not operating. Accordingly, a contract may be made with a power company with respect to power necessary for an operation of the designated facility, and contract power can be suppressed to be low. As a result, an adjustment between power by an operation of the designated facility and power necessary for charging by the charging equipment can be more suitably performed.

In the charging management device of the designated facility of the first aspect of the present disclosure, the charging management device is configured to acquire information related to weather, and
permit charging by the charging device in the parking space for charging that uses the designated power when the designated facility is predicted to not operate based on the information related to weather.
   Accordingly, charging by the charging device in the parking space for charging in a facility where an operation is influenced by the weather can be more suitably permitted.

A charging management device of a designated facility of a second aspect of the present disclose is
a charging management device of a designated facility that jointly provides a parking space for charging where a charging device that charges a vehicle-mounted battery is installed, in which the charging management device is configured to
acquire contract power of the designated facility and usage power,
prohibit charging by the charging device in the parking space for charging when a power difference that subtracts the usage power from the contract power of the designated facility is less than a designated power, and
permit charging by the charging device in the parking space for charging that uses the designated power when the power difference is equal to or more than the designated power.

The designated facility of the second aspect of the present disclosure jointly provides a parking space for charging where a charging device that charges a vehicle-mounted battery is installed. The charging management device of the designated facility is configured to acquire contract power of the designated facility and usage power. The charging management device is configured to prohibit charging by the charging device in the parking space for charging when a power difference that subtracts the usage power from the contract power of the designated facility is less than a designated power. The charging management device is configured to permit charging by the charging device in the parking space for charging that uses the designated power when the power difference is equal to or more than the designated power. Namely, charging by the charging device in the parking space for charging is permitted when a power difference that subtracts the usage power from the contract power of the designated facility is equal to or more than the designated power. Accordingly, a contract may be made with a power company with respect to usage power of the designated facility, and contract power can be suppressed to be low. As a result, an adjustment between power by an operation of the designated facility and power necessary for charging by the charging equipment can be more suitably performed.

In the charging management device of the designated facility of the second aspect of the present disclosure, the charging management device may be configured to acquire an operation time of the designated facility, and
permit charging by the charging device in the parking space for charging during a non-operation time of the designated facility and when the power difference is equal to or more than the designated power.
   Namely, charging by the charging device in the parking space for charging is permitted during a non-operation time of the designated facility and when the power difference that subtracts the usage power from the contract power of the designated facility is equal to or more than the designated power. In this case, charging by the charging device in the parking space for charging that uses power within a range of the power difference may be used when the power difference is less than the designated power. Accordingly, normally, charging can be performed by the charging device in the parking space for charging that uses power within a range of the power difference.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a configuration of designated facility 20 including a charging management device according to an embodiment of the present disclosure;

FIG. 2 is a configuration diagram illustrating an outline of a configuration of a vehicle in which the chargeable parking lot 32 can be used;

FIG. 3 is a flowchart illustrating an example of a charge management process executed by the electronic control unit 60;

FIG. 4 is an explanatory diagram illustrating an example of a relationship between an operation time of the designated facility 20 and electric power required for charging by the charging device 35;

FIG. 5 is a flow chart illustrating an example of a charge managing process according to a modification; and

FIG. 6 is a flowchart illustrating an example of a charge management process according to a modification.

### DETAILED DESCRIPTION OF EMBODIMENTS

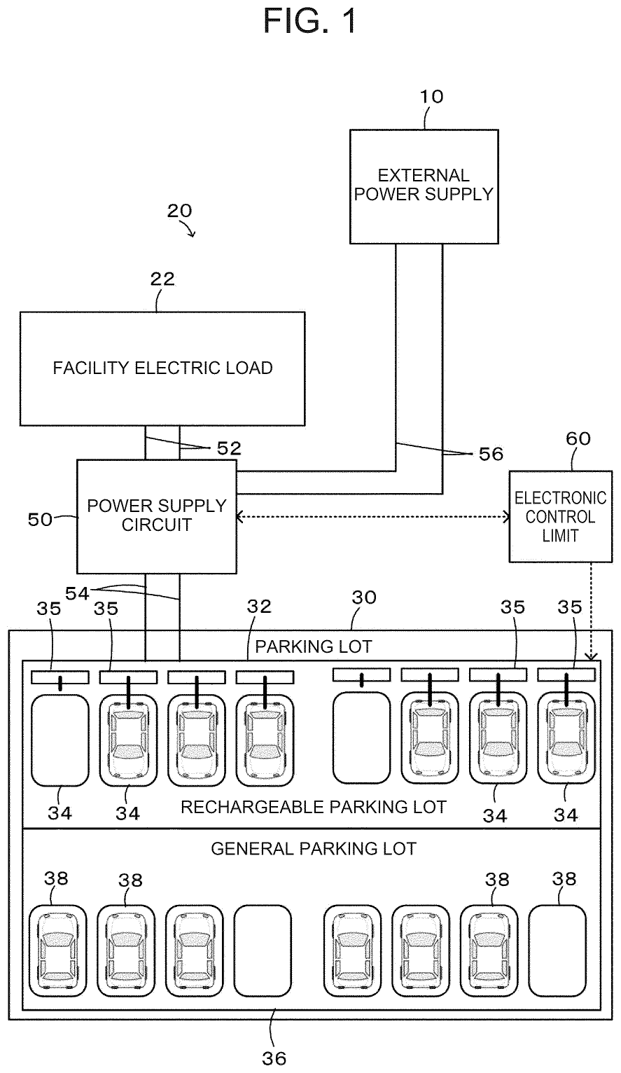

Next, an embodiment for carrying out the present disclosure will be described. FIG. 1 is a configuration diagram schematically illustrating a configuration of a designated facility 20 including a charging management device according to an embodiment of the present disclosure. As illustrated, the designated facility 20 of the embodiment includes a facility electric load 22, a parking lot 30, a power supply circuit 50, and an electronic control unit 60. The electronic control unit 60 corresponds to the charging management device of the embodiment.

The designated facility 20 is, for example, a facility such as a public facility, a commercial facility, a station, an airport, a hotel, or the like, and corresponds to a facility having a chargeable parking space in which a charging device for charging an in-vehicle battery is installed. The facility electric load 22 corresponds to an electric facility used in the facility.

The parking lot 30 includes a chargeable parking lot 32 and a general parking lot 36. A plurality of parking spaces 34 are arranged in the chargeable parking lot 32, and a charging device 35 for charging and discharging a battery mounted on the vehicle is installed in each parking space 34. A plurality of parking spaces 38 are also arranged in the general parking lot 36.

The power supply circuit 50 is installed between the facility electric load 22 and the chargeable parking lot 32 of the parking lot 30. The power supply circuit 50 is connected to the facility electric load 22 by a power line 52 and to each charging device 35 of the chargeable parking lot 32 by a power line 54. The power supply circuit 50 is connected to an external power source 10 such as a commercial power supply. The power supply circuit 50 adjusts the voltage of the electric power supplied from the external power source 10 and supplies the adjusted voltage to the facility electric load 22 and the charging device 35.

The electronic control unit 60 is configured as a microcomputer centered on a CPU (not shown). The electronic control unit 60 receives a voltage Vin from a voltage sensor (not shown) attached to the external power source 10 and a current Iin from a current sensor (not shown). The electronic control unit 60 receives a voltage Vout from a voltage sensor (not shown) attached to the facility electric load 22 and a current Iout from a current sensor (not shown). The electronic control unit 60 receives a voltage Ved from a voltage sensor (not shown) attached to a power line 54 connected to the respective charging devices 35 of the chargeable parking lot 32, a current Icd from a current sensor (not shown), and the like. Further, the electronic control unit 60 outputs a control signal or the like to each charging device 35 of the chargeable parking lot 32. Further, the electronic control unit 60 outputs a drive control signal to each relay (not shown) attached to each power line 52, 54, 56 in the power supply circuit 50. The electronic control unit 60 outputs a drive control signal or the like to each power conversion device (not shown) attached to each of the power lines 52, 54, and 56 in the power supply circuit 50.

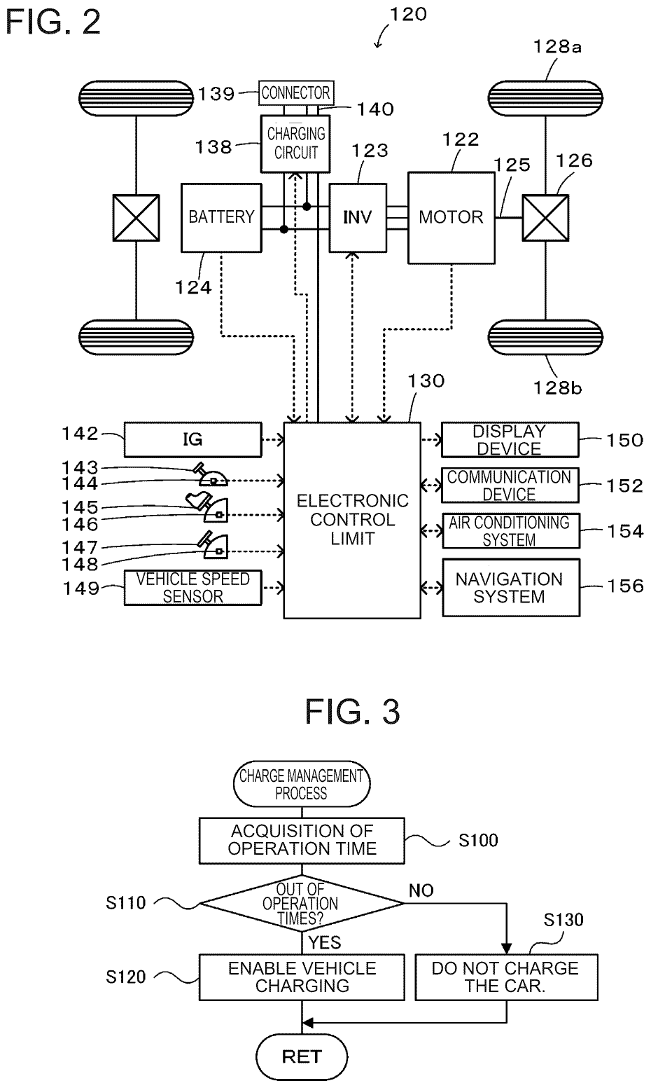

Examples of vehicles that can use the chargeable parking lot 32 of the parking lot 30 include electrified vehicle 120 illustrated in FIG. 2. Electrified vehicle 120 includes a motor 122, an inverter 123, a battery 124, charging circuit 138, a connector 139 and an electronic control unit 130.

The motor 122 is configured as, for example, a synchronous generator motor. The rotor of the motor 122 is connected to a drive shaft 125 connected to the drive wheel 128a, 128b via a differential gear 126. The motor 122 is driven when DC power from the battery 124 is converted into three-phase AC power by the inverter 123 and three-phase AC power is applied by the inverter 123. The battery 124 is configured as a well-known lithium-ion secondary battery or a nickel-hydrogen secondary battery.

The charging circuit 138 has one end connected to a power line connected to the battery 124, and the other end connected to a connector 139 for connecting to the charging device 35. The charging circuit 138 includes a charging relay (not shown), and can be connected to or disconnected from the battery 124 by the charging relay.

The electronic control unit 130 is configured as a microcomputer that is not shown but is configured with a CPU as a center. The electronic control unit 130 receives signals from various sensors via an input port. For example, the electronic control unit 130 receives an ignition signal from the ignition switch 142. The electronic control unit 130 receives the shift position SP from the shift position sensor 144 that detects the position of the shift lever 143. The electronic control unit 130 receives the accelerator operation amount Acc from the accelerator pedal position sensor 146 that detects the depression amount of the accelerator pedal 145. The electronic control unit 130 receives the brake position BP from the brake pedal position sensor 148 that detects the depression amount of the brake pedal 147. The electronic control unit 130 inputs the vehicle speed V and the like from the vehicle speed sensor 149. The electronic control unit 130 also inputs a rotational position θ from a rotational position sensor (not shown) that detects the rotational position of the motor 122. The electronic control unit 130 receives a battery voltage Vb from a voltage sensor (not shown) attached to the output terminal of the battery 124. The electronic control unit 130 receives a battery current Ib from a current sensor (not shown) attached to the output terminal of the battery 124. The electronic control unit 130 receives a charge/discharge voltage Vchg from a voltage sensor attached to the charging circuit 138. The electronic control unit 130 receives a charge/discharge current Ichg or the like from a current sensor attached to the charging circuit 138.

The electronic control unit 130 outputs various control signals via an output port. For example, the electronic control unit 130 outputs a display control signal to the display device 150, a communication control signal to the communication device 152, and an air-conditioning control signal to the air-conditioning device 154. Further, the electronic control unit 130 outputs a switching control signal for switching a switching element (not shown) to the inverter 123 for driving the motor 122. The electronic control unit 130 outputs a drive control signal to a system main relay (not shown) mounted in the vicinity of the battery 124. The electronic control unit 130 outputs a drive control signal to a charging relay (not shown) attached to the charging circuit 138. The electronic control unit 130 communicates with a navigation system 156 that displays various types of information and performs route guidance. A signal line 140 for communicating with the charging device 35 when the charging device 35 is connected via the connector 139 is connected to the electronic control unit 130.

Next, a charge management process performed by the electronic control unit 60 functioning as a charging management device of the designated facility 20 according to the embodiment configured as described above will be described. FIG. 3 is a flowchart illustrating an example of a charge management process executed by the electronic control unit 60. This process is repeatedly executed at predetermined time intervals (for example, every minute, every 10 minutes, every 30 minutes, every hour, or the like).

When the charge managing process is executed, the electronic control unit 60 first acquires the operation times of the designated facility 20 (S100). The acquisition of the operation time of the designated facility 20 is preferably performed according to a specific day of a weekday, a holiday, a holiday, or a New Year holiday. Next, it is determined whether or not it is outside the operation times of the designated facility 20 (S110). When it is determined that the time is outside the operation time of the designated facility 20, the charging of the battery 124 mounted on the vehicle by the charging device 35 in the chargeable parking lot 32 is permitted (S120), and this process is ended. On the other hand, when it is determined that it is not outside the operation time of the designated facility 20 (during the operation time), charging of the battery 124 mounted on the vehicle by the charging device 35 of the chargeable parking lot 32 is prohibited (S130), and the process ends.

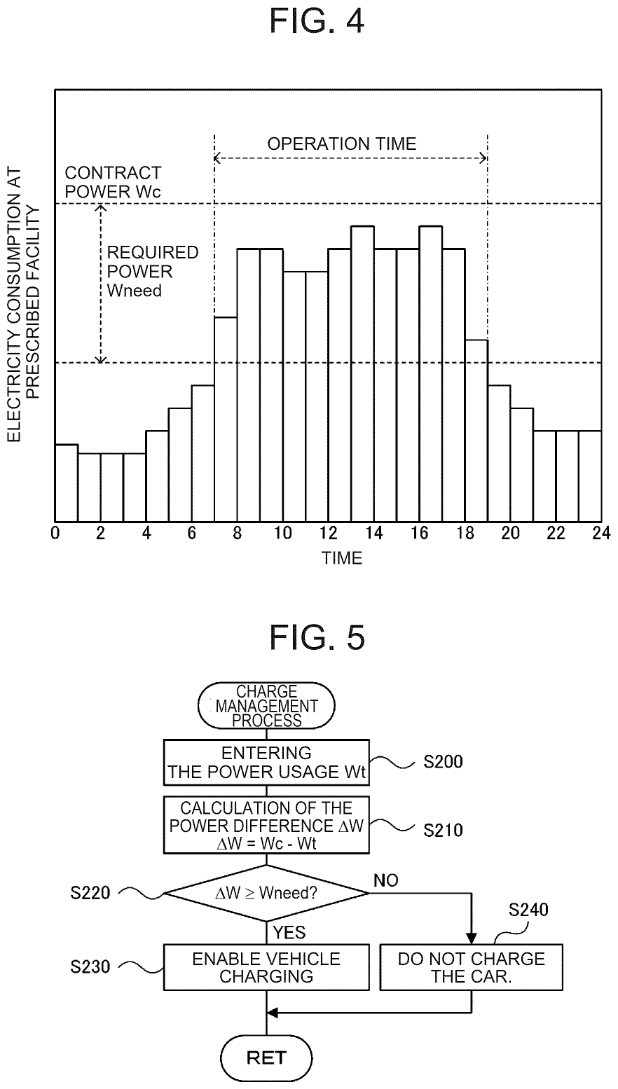

FIG. 4 is an explanatory diagram illustrating an example of a relationship between the operation time of the designated facility 20 and electric power required for charging by the charging device 35. As illustrated, the power used by the designated facility 20 is small from 7:00 to 19:00 of the operation time, and the power used by the designated facility 20 is small from 0:00 to 7:00 and from 19:00 to 24:00 of the non-operation time. In the non-operation time, the power difference ΔW between the contract power Wc with the external power source 10 of the designated facility 20 and the usage power Wt of the designated facility 20 is larger than the power (charge required power) Wneed required for charging the battery 124 mounted in the vehicle by the charging device 35 of the chargeable parking lot 32. Therefore, even if the charging device 35 of the chargeable parking lot 32 permits the battery 124 mounted on the vehicle to be charged at the non-operation time, the contract power Wc is not exceeded.

The charging management device of the designated facility 20 according to the embodiment described above acquires the operation time of the designated facility 20. The charging management device permits the charging of the battery 124 mounted on the vehicle by the charging device 35 of the chargeable parking lot 32 when it is outside the operation time of the designated facility 20. The charging management device prohibits the charging of the battery 124 mounted on the vehicle by the charging device 35 of the chargeable parking lot 32 when it is not outside the operation time of the designated facility 20. Accordingly, it is possible to prevent the battery 124 mounted on the vehicle from being charged by the charging device 35 in the chargeable parking lot 32 from exceeding the contract power Wc. As a result, the adjustment of the electric power by the operation of the designated facility 20 and the electric power required for charging by the charging device 35 can be made more appropriate.

In the charging management device of the designated facility 20 according to the embodiment, the operation time of the designated facility 20 is acquired, and the charging of the battery 124 mounted on the vehicle by the charging device 35 of the chargeable parking lot 32 is permitted or not depending on whether or not the operation time of the designated facility 20 is outside the operation time. However, the charging management device may acquire the weather in the vicinity of the designated facility 20 and predict whether or not the designated facility 20 operates based on the acquired weather. The charging management device may prohibit the charging of the battery 124 mounted on the vehicle by the charging device 35 of the chargeable parking lot 32 when it is predicted that the designated facility 20 is operating. The charging management device may allow the charging of the battery 124 mounted on the vehicle by the charging device 35 of the chargeable parking lot 32 when it is predicted that the designated facility 20 is not to be operated.

In the charging management device of the designated facility 20 according to the embodiment, the operation time of the designated facility 20 is acquired, and the charging of the battery 124 mounted on the vehicle by the charging device 35 of the chargeable parking lot 32 is permitted or not depending on whether or not the operation time of the designated facility 20 is outside the operation time. However, depending on whether or not the power difference ΔW between the contract power Wc with the external power source 10 of the designated facility 20 and the usage power Wt of the designated facility 20 is equal to or more than Wneed of electric power (electric power required to be charged) required for charging the battery 124 mounted in the vehicle by the charging device 35 of the chargeable parking lot 32, the charging of the battery 124 mounted in the vehicle by the charging device 35 of the chargeable parking lot 32 may be allowed or denied. An example of the charge management process in this case is shown in FIG. 5.

In the charge managing process of FIG. 5, the electronic control unit 60 first inputs the usage power Wt used by the facility electric load 22 of the designated facility 20 (S200). The electronic control unit 60 calculates the power difference ΔW between the contract power Wc with the external power source 10 of the designated facility 20 and the usage power Wt of the designated facility 20 (S210). Then, it is determined whether or not the power difference ΔW is equal to or higher than the electric power (electric power required for charging) Wneed required for charging the battery 124 mounted in the vehicle by the charging device 35 of the chargeable parking lot 32 (S220). When it is determined that the power difference ΔW is equal to or larger than the charging required power Wneed, the charging device 35 of the chargeable parking lot 32 permits the charging of the battery 124 mounted on the vehicle (S230), and the process ends. On the other hand, when it is determined that the power difference ΔW is less than the charging required power Wneed, the charging of the battery 124 mounted on the vehicle by the charging device 35 in the chargeable parking lot 32 is prohibited (S240), and this process is ended. Even in the charge managing process of the modification, it is possible to prevent the contract power Wc from being exceeded when the battery 124 mounted on the vehicle is charged by the charging device 35 of the chargeable parking lot 32. This makes it possible to make the adjustment between the electric power generated by the operation of the designated facility 20 and the electric power required for charging by the charging device 35 more appropriate.

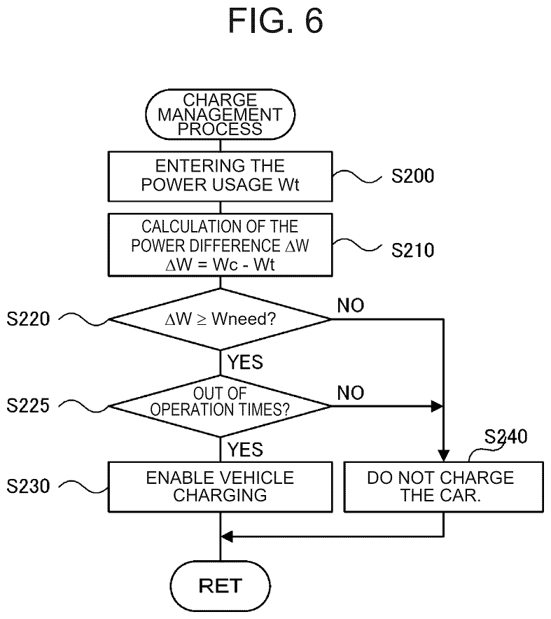

Further, when it is determined that the operation time of the designated facility 20 is in progress and the power difference ΔW is equal to or larger than the charging required power Wneed, the charging device 35 of the chargeable parking lot 32 may permit the charging of the battery 124 mounted on the vehicle. An example of the charge management process in this case is shown in FIG. 6. In the charge management process of FIG. 6, a process of a S225 for determining whether or not the charge management process is outside the operation times of the designated facility 20 is provided between S220 and S230 of the charge management process of FIG. 5. In the charge managing process of FIG. 6, the usage power Wt used by the facility electric load 22 of the designated facility 20 is inputted (S200), and the power difference ΔW is calculated (S210). Then, a determination (S220) as to whether or not the power difference ΔW is equal to or more than the required charge power Wneed and a determination (S225) as to whether or not the power difference ΔW is outside the operation times of the designated facility 20 are performed. When it is determined that the power difference ΔW is equal to or more than the charging required power Wneed and is outside the operation time of the designated facility 20, the charging of the battery 124 mounted in the vehicle by the charging device 35 in the chargeable parking lot 32 is permitted (S230), and the process ends. On the other hand, when it is determined that the power difference ΔW is less than the charging required power Wneed or is within the operation time of the designated facility 20, the charging of the battery 124 mounted on the vehicle by the charging device 35 of the chargeable parking lot 32 is prohibited (S240), and this process is terminated. In this way, it is possible to more reliably prevent the battery 124 mounted on the vehicle from being charged by the charging device 35 in the chargeable parking lot 32 from exceeding the contract power Wc. This makes it possible to further optimize the adjustment of the electric power by the operation of the designated facility 20 and the electric power required for the charging by the charging device 35.

In the charging management device of the designated facility 20 according to the embodiment, an electrified vehicle 120 in which the chargeable parking lot 32 of the parking lot 30 is used as a usable vehicle by driving the motor 122 using electric power from the battery 124 is assumed. However, a vehicle equipped with a rechargeable battery may be used. For example, vehicles having various configurations such as a hybrid electric vehicle in which an engine, a motor, and a battery are mounted, and a fuel cell electric vehicle in which a fuel-cell and a battery are mounted may be used.

The correspondence between the main elements of the embodiments and the main elements of the disclosure described in the column of the means for solving the problem will be described. In the embodiment, the battery 124 corresponds to a “battery”. The charging device 35 corresponds to a “charging device”. The parking space 34 corresponds to a “parking space for charging”. the designated facility 20 corresponds to a “predetermined facility”. The electronic control unit 60 corresponds to a “charging management device”.

The correspondence between the main elements of the embodiment and the main elements of the disclosure described in the section of the means for solving the problem is an example for specifically explaining the embodiment of the disclosure described in the section of the means for solving the problem. It does not limit the elements of the disclosure described in the section of the means for solving the problem. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of a charging management device of a designated facility, and the like.

What is claimed is:

1. A charging management device of a designated facility that jointly provides a parking space for charging where a charging device that charges a vehicle-mounted battery is installed, wherein the charging management device is configured to
acquire an operation time of the designated facility,
prohibit charging by the charging device in the parking space for charging during an operation time of the designated facility, and
permit charging by the charging device in the parking space for charging that uses designated power other than at the operation time of the designated facility.

2. The charging management device according to claim 1, wherein the charging management device is configured to
acquire information related to weather, and
permit charging by the charging device in the parking space for charging that uses the designated power when the designated facility is predicted to not operate based on the information related to weather.

3. A charging management device of a designated facility that jointly provides a parking space for charging where a charging device that charges a vehicle-mounted battery is installed, wherein the charging management device is configured to
acquire contract power of the designated facility and usage power,
prohibit charging by the charging device in the parking space for charging when a power difference that subtracts the usage power from the contract power of the designated facility is less than a designated power, and
permit charging by the charging device in the parking space for charging that uses the designated power when the power difference is equal to or more than the designated power.

4. The charging management device according to claim 3, wherein the charging management device is configured to
acquire an operation time of the designated facility, and
permit charging by the charging device in the parking space for charging during a non-operation time of the designated facility and when the power difference is equal to or more than the designated power.

5. The charging management device according to claim 4, wherein the charging management device is configured to permit charging by the charging device in the parking space for charging that uses power within a range of the power difference when the power difference is less than the designated power.
